(19) United States
(12) Patent Application Publication
(10) Pub. No.: US 2014/0226343 A1
(43) Pub. Date: Aug. 14, 2014

(54) Ornamental Strand of Glow-in-the-Dark Bulbs

(71) Applicant: Deanna Deas, Charlotte, NC (US)

(72) Inventor: Deanna Deas, Charlotte, NC (US)

(21) Appl. No.: 14/179,070

(22) Filed: Feb. 12, 2014

Related U.S. Application Data
(60) Provisional application No. 61/764,038, filed on Feb. 13, 2013.

(51) Int. Cl. F21K 2/00

(52) U.S. Cl. CPC F21K 2/00
USPC 362/317

(57) ABSTRACT

Described is an ornamental strand of glow-in-the-dark bulbs comprising a plurality of bulbs having a means for glowing in the dark and that are arranged along a strand. The strand of glow-in-the-dark lights resembles a traditional strand of lights, but does not require a power source or any electrical components. The bulbs glow in the dark by means of a phosphorescent material. The bulbs may be composed of a phosphorescent material, coated with a phosphorescent material, or filled with a phosphorescent material. Overall, the present invention provides an ornamental strand of lights for use in decorating a home, tree, or business that does not require the use of electricity.

### CROSS REFERENCE TO RELATED APPLICATION

This application claims the benefit of U.S. Provisional Application No. 61/764,038 filed on Feb. 13, 2013, entitled “Glow-in-the-Dark String Lights.” The above identified patent application is herein incorporated by reference in its entirety to provide continuity of disclosure.

### BACKGROUND OF THE INVENTION

1. Field of the Invention

The present invention relates to glow-in-the-dark lights. More specifically, the present invention relates to a strand of ornamental bulbs wherein the bulbs are capable of glowing in the dark so as to provide a decorative appearance similar to that of a traditional strand of lights, but without using electricity.

Strands of lights are popular ornamental items used to decorate homes and business on holidays and special occasions. However, traditional strands of decorative lights must be connected to an electrical power source, which consumes electricity and therefore generates an additional expense for the user. Furthermore, the fact that electrical lights must be plugged into an outlet at one end limits the number of different decorative configurations that the lights can be displayed in. Locating a power outlet for plugging in lights displayed outdoors is particularly problematic because some homes or businesses are not equipped with an outdoor power outlet. Lastly, traditional strands of lights are prone to electrical problems, resulting in one or more of the bulbs burning out. The user cannot use a strand of lights in which all of the bulbs are burned out, and the user may decide that a strand of lights having one or more burned out bulbs is not visually appealing.

The present invention describes a plurality of bulbs having a means for glowing in the dark and that are arranged along a strand. The strand of bulbs is illuminated by means of a phosphorescent glow-in-the-dark material. The glow-in-the-dark material allows the user to decorate using a strand of lights without the need for an electrical power outlet. Similarly, a user can decorate his or her home without bearing the added expense of providing electricity to a strand of lights. Further, bulbs illuminated by glow-in-the-dark means do not suffer from electrical failures and burned out bulbs.

2. Description of the Prior Art

Devices have been disclosed in the prior art that relate to glow-in-the-dark decorations. These include devices that have been patented and published in patent application publications. These devices generally relate to glow-in-the-dark decorations and toys. The following is a list of devices deemed most relevant to the present disclosure, which are herein described for the purposes of highlighting and differentiating the unique aspects of the present invention, and further highlighting the drawbacks existing in the prior art.

U.S. Patent Publication Number 2006/0228472 to Van Dyn Hoven entitled “Light Surround” discloses decorative ornaments designed to provide light through a decorative casing. The device includes a light source that is surrounded by a decorative encasing such as a heart, star, or cross, among others. In some embodiments, the surround may include various phosphors that emit visible light upon excitement from ultraviolet light. Thus, Van Dyn Hoven discloses a surround or casing adapted to receive a light source. The device disclosed by Van Dyn Hoven requires the use of an electrical power source, and does not disclose the use of a glow-in-the-dark material as the light source for the decoration.

U.S. Pat. No. 6,619,810 to Kramer et al. entitled “Halloween Treat Carrier Including Glow-In-The-Dark Material, Pumpkin Decorating Kit, and Method for Decorating a Pumpkin” discloses a Halloween treat carrier having a Halloween design, wherein the design or the carrier comprises glow-in-the-dark material. Kramer et al. further discloses a pumpkin decorating kit that includes jack-o-lantern designs composed of glow-in-the-dark materials that can be affixed to a pumpkin. Thus, Kramer et al. discloses the use of glow-in-the-dark material for an ornamental purpose, but does not disclose glow-in-the-dark material for use on a strand of bulbs.

U.S. Design Pat. No. D574,291 to Liuzzi et al. entitled “Decorative Lighting Bag” discloses a design for a bag that has a rounded or spherical shape on which a jack-o-lantern design is carved out, such that a light source in the interior of the bag can shine through the design. Liuzzi provides a decorative item having a light source, but does not disclose a strand of decorative lights illuminated by glow-in-the-dark means.

U.S. Pat. No. 7,609,006 to Gibboney entitled “LED Light String with Split Bridge Rectifier and Thermistor Fuse” discloses a string of lights having a plurality of LEDs in series with a negative temperature coefficient thermistor. The LED lights are powered by direct current, but the string passes alternating current from the electrical plug to the receptacle at the other end of the string of lights. Thus, Gibboney discloses a string of lights in electrical connection and wherein LEDs provide light. Gibboney does not disclose a strand of bulbs having a means for glowing in the dark.

U.S. Pat. No. 8,163,201 to Agrawal et al. entitled “High-Intensity Persistent Photoluminescent Formulations and Objects, and Methods for Creating the Same” discloses various formulations of phosphorescent materials that produce high luminous intensity and persistence. Such formulations comprise phosphorescent materials, a liquid carrier medium, a polymeric resin, and stabilizing additives. Further, Agrawal et al. discloses a method for creating photoluminescent objects comprising a photoluminescent formulation and a preformed article. Thus, Agrawal et al. is directed to specific formulations of glow-in-the-dark materials, whereas the present invention is not limited to particular glow-in-the-dark materials and instead discloses a strand of bulbs that are capable of glowing in the dark.

These prior art devices have several known drawbacks. Several of the prior art references disclose the use of glow-in-the-dark materials for decorative or ornamental purposes. However, the prior art does not disclose the use of glow-in-the-dark materials as the means for providing illumination on a strand of lights. Other prior art devices recite decorative objects utilizing electrically powered light sources. Such devices maintain the drawback that the decorative objects consume electricity and generate an expense for the user.

In light of the devices in the prior art, it is submitted that the present invention is substantially divergent in design elements from the prior art and consequently it is clear that there is a need in the art for an improvement to existing ornamental strands of lights. In this regard the instant invention substantially fulfills these needs.

### SUMMARY OF THE INVENTION

In view of the foregoing disadvantages inherent in the known types of decorative strands of lights now present in the prior art, the present invention provides a new decorative strand of glow-in-the-dark bulbs wherein the same can be utilized for providing convenience for the user when decorating using a strand of lights.

It is therefore an object of the present invention to provide a new and improved decorative strand of glow-in-the-dark lights that has all of the advantages of the prior art and none of the disadvantages.

It is another object of the present invention to provide a strand of lights that does not require a connection to an electrical power source.

Another object of the present invention is to provide a strand of lights that does not consume electricity.

Yet another object of the present invention is to provide a strand of lights for decorating trees, homes, or businesses that illuminates by means of a glow-in-the-dark material.

Another object of the present invention is to provide a strand of lights that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the preferred embodiment of the present invention.

FIG. 2 shows a working view of the preferred embodiment of the present invention arranged decoratively on a home.

### DETAILED DESCRIPTION OF THE INVENTION

Reference is made herein to the attached drawings. Like reference numerals are used throughout the drawings to depict like or similar elements of the strand of glow-in-the-dark lights. For the purposes of presenting a brief and clear description of the present invention, the preferred embodiment will be discussed as used for decorating a home, business, or tree. The figures are intended for representative purposes only and should not be considered to be limiting in any respect.

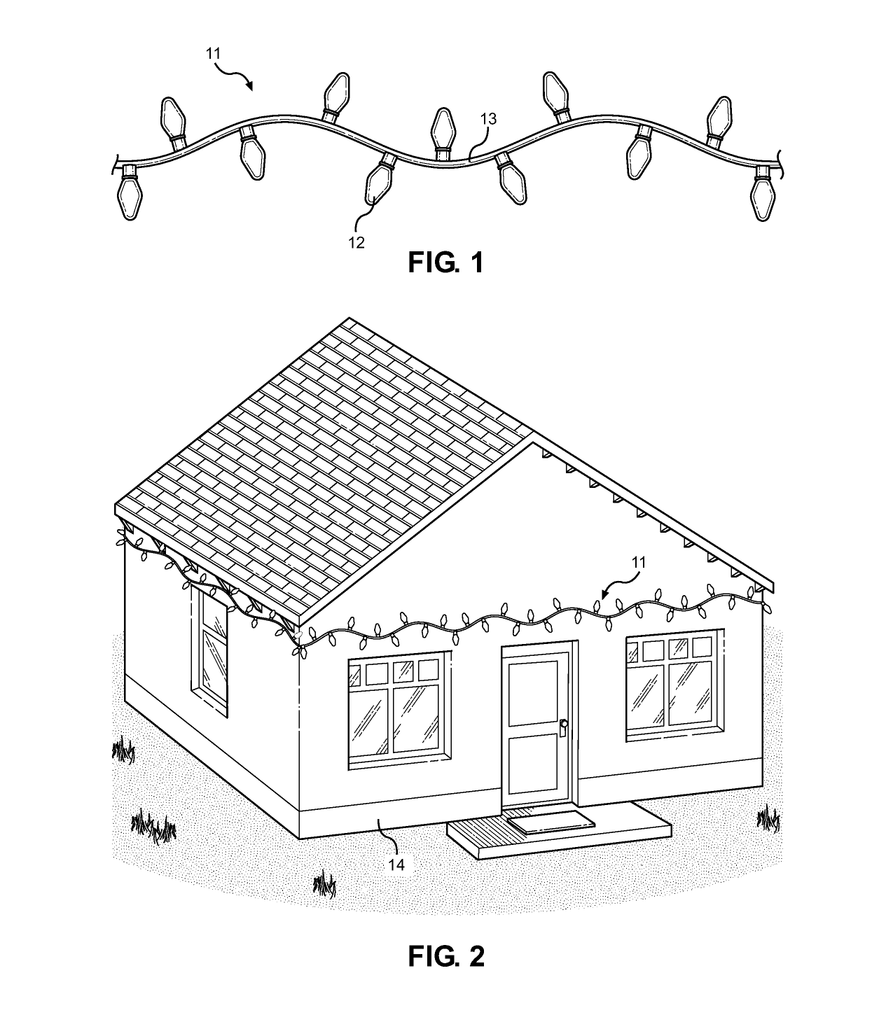

Referring now to FIG. 1, there is shown a perspective view of the preferred embodiment of the present invention. The ornamental strand of bulbs 11 comprises a plurality of bulbs 12 arranged along a strand 13. The bulbs are arranged on the strand in the same fashion as a traditional strand of lights. The bulbs are preferably evenly spaced along the strand, but no claim is made as to the precise orientation of the bulbs 12 in relation to each other. The bulbs 12 can have any shape, including a spherical shape or a tear drop shape. The strand may be composed of a variety of materials, including but not limited to string, rubber, metal wire, or plastic. Further, in one embodiment of the present invention the bulbs may be removably attachable to the strand. In this way, a user can customize the strand by interchanging the bulbs, and by selecting the color and arrangement of bulbs on the strand. Unlike traditional strands of lights in which incandescent light bulbs or LEDs are in electrical connection, the present invention does not require electrical components. Thus, the strand does not need to include any electrically conductive materials running through the length of the strand, nor does it require a power source.

The bulbs have a means for glowing-in-the-dark, which can be achieved in any of a variety of ways. The bulbs may be fabricated from glow-in-the-dark materials or a glow-in-the-dark pigment may be mixed with the material used to form the bulbs. Further, the bulbs may be composed of plastic or other suitable material and may then be coated with glow-in-the-dark paint or spray. Additionally, the bulbs may be formed so as to have a hollow interior that is then filled with glow-in-the-dark material. For example, the bulbs may be filled with a glow-in-the-dark powder. Any of these means of providing bulbs capable of glowing-in-the-dark would achieve the goals of the present invention.

Phosphorescent materials that exhibit a glow-in-the-dark effect are well known and described in the art. Such materials include glow-in-the-dark pigments and glow-in-the-dark paint. Common phosphorescent compounds used to produce a glow-in-the-dark effect include zinc sulfide and strontium aluminate. Zinc sulfide is commonly used to create glow-in-the-dark toys and other novelty items. Strontium aluminate has greater luminance and glows for a longer period of time than does zinc sulfide. These phosphorescent compounds are capable of producing various colors of light. Thus, in one embodiment of the present invention, the bulbs on the strand produce a variety of colors. Phosphorescent glow-in-the-dark materials must be exposed to light for a period of time, referred to as “charging,” before said material can exhibit a glow-in-the-dark effect. The glow-in-the-dark bulbs of the present invention can charge during the day when they are exposed to light and can then exhibit a phosphorescent effect when it is dark.

Referring now to FIG. 2, there is shown a view of the glow-in-the-dark strand of bulbs of the preferred embodiment of the invention arranged decoratively on a home. The strand of bulbs 11 are shown as being arranged along an outside surface of a home 14. The bulbs on a strand may all be the same color, or the bulbs may be a variety of colors. The strand of bulbs can be placed wherever the user desires because the present invention does not need to be plugged into an electrical outlet. In this way, the strand of lights eliminates the clutter associated with conventional strands of lights. Conventional strands of lights arranged on the roof of a house must be plugged into a power outlet on the ground floor of the house via a tangled clutter of power cords. The strand of lights of the present invention may be suspended in place using any commonly known technique for hanging decorative lights. This includes suspending the strand of bulbs using hooks, clips, ties, or any other suitable fasteners. Further, the strand of bulbs does not need to be switched on and off in order to illuminate the lights. Instead, the strand of lights will charge during the day and will glow in the dark at night, without any intervention by part of the user.

Strands of lights are a popular decoration for holidays and other special occasions. However, traditional lights require the use of electricity, which generates an expense for the user. Further, traditional lights must be connected to a power source, which may limit the places in which the user may hang the strand of lights because many users may not have a power outlet near the place where the user wants to hang the strand of lights. This is particularly problematic in outdoor settings in which power outlets may not be readily accessible. In order for a user to hang lights in an area distant from a power outlet, the user must connect extension cords to the strand of lights to reach a power outlet. However, the user may find these additional power cables to be visually unappealing.

The present invention provides a strand of bulbs that can glow-in-the-dark in order to provide a user with a decorative strand of lights that does not require an electrical connection. The present invention eliminates the need for the user to plug in the strand of lights, which enables the user to hang the lights in a variety of locations without having to locate a power source for the lights. The glow-in-the-dark lights automatically illuminate at night without requiring any intervention by the user. Overall, the present invention provides a strand of glow-in-the-dark lights to provide a home, business, or tree with an ornamental appearance similar to that of a traditional strand of lights, but without the added expense of providing power to the lights.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A decorative strand of glow-in-the-dark lights, comprising:
a plurality of bulbs disposed on a strand;
wherein said plurality of bulbs have a means for glowing in the dark.

2) The strand of claim 1, wherein said plurality of bulbs is evenly spaced along said strand.

3) The strand of claim 1, wherein said plurality of bulbs are coated with glow-in-the-dark paint.

4) The strand of claim 1, wherein said plurality of bulbs are fabricated using glow-in-the-dark material.

5) The strand of claim 1, wherein said plurality of bulbs comprise a hollow interior and wherein glow-in-the-dark material is deposited inside said hollow interior.

6) The strand of claim 1, wherein said plurality of glow-in-the-dark bulbs produce light of the same color.

7) The strand of claim 1, wherein said plurality of glow-in-the-dark bulbs produce at least two colors of light.

8) The strand of claim 1, wherein said plurality of glow-in-the-dark bulbs are removably attached to said strand such that said plurality of glow-in-the-dark bulbs are interchangeable on said strand.
